(19) United States
(12) Patent Application Publication
(10) Pub. No.: US 2008/0158115 A1
(43) Pub. Date: Jul. 3, 2008

(54) Led Display System

(75) Inventors: Claus Nico Cordes, Eindhoven (NL); Jurgen Jean Louis Hoppenbrouwers, Eindhoven (NL); Oleg Belik, Eindhoven (NL); Francisco Paulus Maria Budzelaar, Eindhoven (NL); Andrea Giraldo, Eindhoven (NL); Nijs Cornelis Van Der Vaart, Eindhoven (NL); Ingrid Maria Laurentia Cornelia Vogels, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,000

(22) PCT Filed: Mar. 28, 2006
(86) PCT No.: PCT/IB2006/050943

§ 371 Date: Sep. 28, 2007

(30) Foreign Application Priority Data
Apr. 4, 2005 (EP) 05102638.3

(51) Int. Cl. G09G 3/32

(52) U.S. Cl. 345/82; 345/83

(57) ABSTRACT

A method of displaying an input signal (IV) on a full color LED display is discussed wherein the display has pixels (11) comprising at least four LED's (PLi) which respectively emit light with four primary colors. The method comprises converting (SC) the input signal (IV) into drive signals for the at least four LED's (PLi). The converting (SC) comprises: (i) determining (RD) valid ranges (VRi) of at least two of the drive signals (DSi) to obtain a color of the combined light emitted which fits the input signal (IV), (ii) determining (LD) a gradation or lifetime indication (LTi) of the at least two LED's (PLi) for associated ones of the drive signals (DSi) within the valid ranges (VRi), and (iii) determining (CD) a combination (DCi) of values of drive signals (DSi) providing substantially the minimum degradation, or the maximum lifetime, of a combination of the at least two LED's (PLi) based on the degradation or lifetime indications (LTi).

### FIELD OF THE INVENTION

The invention relates to a signal converter for a full color LED display, a full color LED display system comprising the signal converter, a display apparatus comprising the full color LED display system, and a method of displaying an input signal on a full color LED display.

### BACKGROUND OF THE INVENTION

US 2004/0178974 A1 discloses a color OLED display system which has an improved performance. The color gamut saturation (further referred to as the saturation) is controlled to reduce the power consumption or to increase the lifetime of at least one of the OLED's. The lifetime of the OLED decreases or the OLED degrades more rapidly, when the current density used to drive the OLED increases. The display system includes a full-color display device which has pixels comprising three or more emissive OLED's which provide three or more primary colors. In one embodiment, the pixels comprise OLED's which emit red, green, blue and white light, respectively. In the now following these OLED's are referred to as the R, G, B, W-OLED, respectively. In another embodiment, the pixels comprise OLED's which emit red, green, blue and yellow or cyan light, respectively.

The R, G, B input signals for each one of the pixels have to be converted into the drive signals required for the four OLED's to obtain a resultant color of the combined light emitted which is equal to the luminance obtained when only three OLED's are used per pixel. With color is meant the luminance (intensity) and chrominance of the light. Dependent on the color to be displayed by the pixel, many combinations of drive signals for the four OLED's may produce the required color. The lifetime of the different OLED's at a same current density differ. It is proposed to maintain the lifetime of the display by limiting the maximum current density of the different OLED's to different values such that their lifetime becomes more equal. The limitation of the maximum current density is however only possible if the saturation is decreased. Because, at a high saturation and a high luminance, the current density of the OLED which has to emit the majority of the light must be higher than the maximum allowed value.

### SUMMARY OF THE INVENTION

It is an object of the invention to provide an LED display system of which the lifetime is optimized without having to decrease the saturation.

A first aspect of the invention provides a signal converter for a full color LED display as claimed in claim 1. A second aspect of the invention provides a full color LED display system as claimed in claim 7. A third aspect of the invention provides a display apparatus comprising the full color LED display system as claimed in claim 8. A fourth aspect of the invention provides a method of displaying an input signal on a full color LED display as claimed in claim 9. Advantageous embodiments are defined in the dependent claims.

The full color LED (Light Emitting Device) display system has a display with pixels which comprise at least four LED's respectively emitting light with four primary colors. For example, each pixel comprises LED's which emit red, green, blue, and white or cyan light, respectively. These LED's are also referred as the red, green, blue, white or cyan LED's.

A signal processor converts the input signal into drive signals for the at least four LED's of the pixels. Usually, the input signal is a red, green, blue signal which directly can be supplied to a display system in which the pixels have red, green, blue LED's. But, the input signal may also be a composite video signal or a YUV signal instead of an RGB signal. It is known from the prior art how to convert the input signal into four or more drive signals suitable for driving the at least four LED's such that the combined light emitted by the at least four LED's has the desired color defined by the input signal. The pixels are defined as comprising the at least four LED's. This does not mean that the LED's of a same pixel must be driven during the same period in time, or that the sub-pixels which comprise the LED's have to be arranged directly adjacent. This terminology is only used to indicate the combined light output of the LED's, and to indicate the combined lifetime or degradation of the LED's. The combined light output is relevant because the LED's should be driven such that the combined light output of the LED's of a pixel is preferably as close as possible to the color indicated by the input signal. The combined lifetime is relevant because, in accordance with the invention, the group of LED's, which together are referred to as a pixel, is driven such that the lifetime of the LED of the group which has the minimum lifetime has the maximum value for its lifetime. Or said differently, the group of LED's is driven such that its overall lifetime, which is determined by the lowest of all individual sub-pixel's lifetimes, is maximized.

The signal converter determines possible combinations of drive values. The possible combinations provide the desired color of the combined light emitted by the group of LED's of a pixel which fits the input signal. These possible combinations are also referred to as valid combinations.

The signal processor further determines a degradation or lifetime of the LED's for the possible combinations of the drive signals. Finally, the signal processor determines, from the possible combinations, the combination of drive values which provides the minimum degradation, or the maximum overall lifetime for the pixel. Consequently, the lifetime of the pixel is maximized without having to decrease the saturation. For example, if the above approach is preformed for all the LED's of the pixel, the lifetime of the pixel is optimized in all situations. Alternatively, if it is known that the lifetime of the pixel is determined by only two of the LED's, only the degradation of these two LED's has to be checked. For example, in today's practice of OLED displays, the blue OLED has a lifetime which is relatively short with respect to the lifetime of the red and green OLED. The lifetime of the blue OLED is increased by adding a cyan OLED. Such a cyan OLED has a lifetime which is longer than that of the blue OLED, but which is shorter than that of the red and green OLED. It now suffices to select the drive of the blue and the cyan OLED such that the lifetime of the combination of the blue and the cyan OLED is maximized. Thus, the current densities in the blue and the cyan OLED are controlled, as much as possible, within the boundaries determined by the input signal to obtain lifetimes which are as much as possible identical. It is not relevant to keep track of the degradation of the red and green OLED, because these OLED's will not become a limiting factor in the lifetime of the pixel.

Thus, in accordance with the present invention, the drive of the LED's is selected such that the combination of the LED's has the maximum lifetime or the minimum degradation. This in contrast to, for example, maximally driving an extra fourth LED to minimize the drive of another one of the LED's without checking whether the fourth LED becomes the limiting factor in the lifetime. Such a situation may, for example, occur if four LED's are present which emit the colors red, green, blue and cyan. It has to be noted that in this example the lifetime of the blue LED is shorter than of the other LED's. The cyan LED is driven maximally to extend the lifetime of the blue LED. However, now the lifetime of the cyan LED may become the shortest. With “driven maximally” is meant that the cyan LED is driven with an as large as possible drive signal such that still the desired color defined by the present input signal is reached. Thus, the combination of drive signals for the four LED's is selected out of all possible combinations for the desired luminance to be displayed which provides the highest drive level for the cyan LED. In the display system in accordance with the present invention, the drive of the LED's is selected out of possible combinations such that the overall lifetime of the display is maximal.

The LED's may be, for example, inorganic electroluminescence (EL) device, a cold cathode, or an organic LED, like a polymer or small molecule LED.

In an embodiment in accordance with the invention as claimed in claim 2, a set of all possible combinations of drive values which can be used to obtain the desired color of the pixel as defined by the input signal is determined. The degradation or lifetime is determined for each such combination of drive values. The combination of drive values is selected which provides the minimal overall degradation, or the maximal overall lifetime of the group of the LED's. This is an approach which requires either a high computational effort or a look-up table, also referred to as LUT, which stores the degradation or lifetime reached with a particular combination of drive values.

In an embodiment in accordance with the invention as claimed in claim 3, a calculating unit calculates for the LED's a degradation value indicative of the degradation or lifetime. The calculation unit uses a predetermined degradation function and a history of drive values to calculate the degradation values. In fact, the degradation value is an indicator which indicates the degradation of the corresponding LED up till the present instant. This degradation is determined by the degradation behavior of the corresponding LED as defined by the degradation function, and the previous drive values. The degradation value may also indicate the still available lifetime of the corresponding LED. The degradation value is stored in a memory. The combination of drive values which is selected is now based on the degradation or lifetime indications PLTi of the possible combinations and on the stored degradation values. Preferably, the selection is performed to obtain a most equal degradation or lifetime for the LED's of a pixel.

The use of the history of the drive values is optional, if it is assumed that the previous drive values were optimized such that equal ageing did occur. Of course, in practice this does not hold exactly, thus, by taking the history into account, much better results can be achieved.

In an embodiment in accordance with the invention as claimed in claim 4, a photo-sensor for measuring the luminance of the at least one of the LED's is added. The sensed luminance is, or the sensed luminances are, used to determine respective sensed degradation values indicating a degradation or lifetime of the at least one of the LED's caused by previous drive values. The combination of drive values which is selected is now based on the degradation or lifetime indications PLTi of the possible combinations and on the sensed degradation values. Preferably, the selection is performed to obtain a most equal degradation or lifetime for the LED's of a pixel. By using the photo-sensor instead of the degradation function, the aging of the LED can be determined more accurate.

Both embodiments as defined in claim 3 or claim 4, take into account that, in practice, the solution freedom is not large enough to guarantee an equal aging of all the LED's. Therefore, despite the use of the lifetime optimization algorithm in accordance with the invention, the ageing of the LED's may differ. By taking this differential ageing into account, it is possible to adjust the selection of the drive values such that further also the differential ageing is reduced. The differential aging is tracked by using the degradation function or the photo-sensor.

In the embodiment defined in claim 3, a frame buffer is used, which for each LED has an entry in which its approximated degradation is stored. This approximated degradation is based on the previous drive values for an LED and the aging characteristic of the LED. However, a frame buffer is expensive in terms of silicon area and the effect is highly dependent on the accuracy of the degradation estimation.

In the embodiment defined in claim 4, the degradation is actually sensed by the photo-sensor. The photo-sensor may be integrated in the pixel. Different photo-sensors may be used for different LED's. It is also possible to use a single photo-sensor for all the LED's of a pixel if the LED's have at least partly non-overlapping on-periods. The photo-sensor senses the brightness of the light as a function of the input drive value. By comparing this light output to a reference light output the degradation of the pixel is known. Preferably, the reference light output is the light output of the LED at its start of use. The ratio of the actual light output at a predetermined drive value and the reference light output at the same predetermined drive value indicates the degradation of the LED. It is of course possible to use as the reference light output a light output at an other instant but than has to be compensated for the use up to the other instant. It is also possible to use another drive value to determine the ratio, but, again, a compensation has to be introduced. The drive values for the LED's are now selected to further decrease the differences in degradation of the different LED's. However, a drawback of this approach is that the pixels have to contain the photo-sensor(s) and that provisions have to be made in the display to feed the sensed information by the photo-sensors to the circuit which determines the selection of the drive values of the LED's out of the set of possible combinations fitting the input signal.

In the embodiment defined in claim 5, the pixels comprise four LED's. For example, red, green, blue and cyan LED's are used. Other combinations of colors are possible, for example, instead of the cyan LED, a white or yellow LED may be used. The degradation or lifetime of the LED's is determined by defining the drive value of three of the four LED's as a function of a fourth one of the four LED's to obtain three drive functions. For example, the drive values of the red, green, and cyan LED's are a function of the drive value of the blue LED. The valid ranges of the drive signals of the four LED's required for obtaining a desired color of the combined light emitted fitting the input signal is determined.

In the now following is meant with the three LED's the LED's for which the three drive functions are expressed as a function of the drive value of the fourth LED. The degradation of the four LED's is expressed by four degradation functions. The degradation functions of the three LED's are a multiplication of a constant with the drive function to the power of a power factor. The degradation function of the fourth LED is a multiplication of a constant and the fourth drive value of the fourth LED to the power of a power factor. The power factors indicate the degradation of the LED's dependent on the associated drive values, and the constants indicate a degradation speed of the LED's.

Next, all fourth drive values are determined for intersections of the four degradation functions, and for the border values of the valid range of the fourth drive value. Now, the lifetimes or degradations are determined of the four LED's for these fourth drive values of the intersections and the border values. Finally, from the determined lifetimes or degradations at these fourth drive values, the fourth drive value associated with the maximum lifetime or the minimum degradation for all sub-pixels involved is selected. The other drive values are then determined by substituting this fourth drive value in the three drive functions.

In the embodiment defined in claim 6, the selected combination of drive values is further based on the drive values of the neighboring pixels. Thus, a combination of drive values is selected deviating from the combination required to reach exactly the minimum degradation or the maximum lifetime in order to also decrease a difference of aging of adjacent pixels.

These and other aspects of the invention are apparent from and will be elucidated with reference to the embodiments described hereinafter.

### BRIEF DESCRIPTION OF THE DRAWINGS

In the drawings:

FIG. 1 shows schematically a display system in accordance with an embodiment of the invention with a display panel which comprises LED's,

FIG. 2 shows an embodiment in accordance with the invention of a pixel drive circuit which comprises a photo-sensor,

FIG. 3 shows a block diagram of a signal converter of an embodiment of the invention,

FIG. 4 shows a block diagram of a signal converter of another embodiment of the invention, and

FIGS. 5A and 5B show graphs elucidating the operation of the signal converter of FIG. 4.

### DETAILED DESCRIPTION OF THE PREFERRED EMBODIMENT

In the now following, references which have capital letters followed by a index indicate a particular item if the index is a particular number, or indicate the item in general if the index is the small letter i. For example, the reference PL1 refers to the LED indicated by this reference in at least one of the Figures. The reference PLi indicates the LED's in general or any sub-group of LED's which are indicated in the Figures only by particular numbers instead of the i. Which items are referred to is clear from the context.

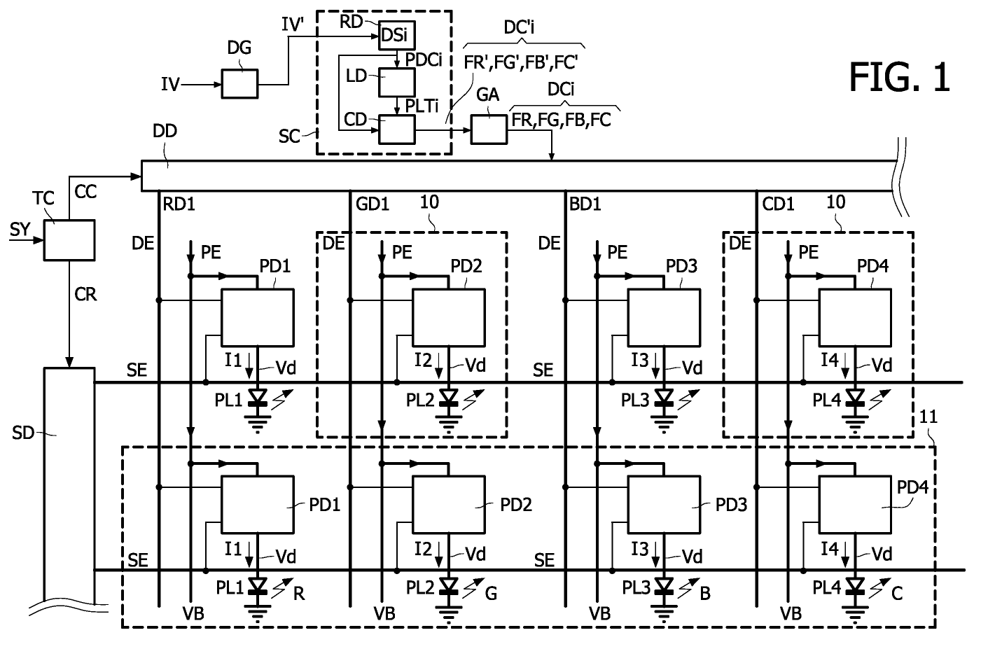

FIG. 1 shows schematically a display system in accordance with an embodiment of the invention with a display panel which comprises LED's. FIG. 1 shows only eight sub-pixels 10 of a matrix display panel 1. Groups of four sub-pixels 10 form a pixel 11. In a practical implementation, the matrix display panel 1 may have many more pixels 11. It is also possible that the pixels 11 are not arranged in a matrix configuration. The sub-pixels 10 need not be arranged in a horizontal line. However for the ease of elucidation, in the now following a matrix display is discussed. Each sub-pixel 10 comprises a light emitting diode further referred to as LED. The LED's PL1, PL2, PL3, PL4 emit different spectrums, for example, red, green, blue and cyan light, respectively. Other primary colors may be used for example, instead of the cyan LED PL4 a white or yellow LED may be used. It is possible to use more than four different LED's. The LED's are collectively referred to as PLi. Each sub-pixel 10 further comprise a pixel driving circuit PD1, PD2, PD3, PD4, also referred to as PDi. The pixel driving circuits generate the drive currents Ii (in the example shown: I1 to I4) through the LED's PLi. The LED's PLi may be, for example, an inorganic electroluminescence (EL) device, a cold cathode, or an organic LED like a polymer or small molecule LED.

By way of example, in FIG. 1 the select electrodes SE extend in the row direction and the data electrodes DE extend in the column direction. It is also possible that the select electrodes SE extend in the column direction and that the data electrodes DE extend in the row direction. The power supply electrodes PE extend in the column direction. The power supply electrodes PE may as well extend in the row direction, or may form a grid. It is possible that a single display line has more select electrodes SE.

Each one of the pixel driving circuits PD1 in the first column of sub-pixels 10 receives a select signal from an associated select electrode SE, a data signal RD1 from an associated data electrode DE, a power supply voltage VB from an associated power supply electrode PE, and supplies the current I1 to its associated LED PL1. Each one of the pixel driving circuits PD2 of the second column of sub-pixels 10 receives a select signal from its associated select electrode SE, a data signal GD1 from its associated data electrode DE, a power supply voltage VB from its associated power supply electrode PE, and supplies a current I2 to its associated LED PL2. Each one of the pixel driving circuits PD3 of the third column of sub-pixels 10 receives a select signal from its associated select electrode SE, a data signal BD1 from its associated data electrode DE, a power supply voltage VB from its associated power supply electrode PE, and supplies a current I3 to its associated LED PL3. Each one of the pixel driving circuits PD4 of the fourth column of sub-pixels 10 receives a select signal from its associated select electrode SE, a data signal CD1 from its associated data electrode DE, a power supply voltage VB from its associated power supply electrode PE, and supplies a current I4 to its associated LED PL4. Although for the same groups of pixels 10 the same references are used to indicate the same elements, the value of signals, voltages and data may be different.

A select driver SD supplies the select signals to the select electrodes SE. A data driver DD receives the signals FR, FG, FB, FC to supply the data signals RD1, GD1, BD1, CD1 to the data electrodes DE. The combination of the signals FR, FG, FB, FC is also referred to as the selected combination DCi of drive signals.

In the embodiment shown in FIG. 1, it is assumed that the input image signal IV comprises the input image component signals R (red), G (green) and B (blue). An optional de-gamma circuit DG receives the input image component signals R, G, B and supplies the corrected signals IV′. The de-gamma circuit DG processes the input image signal IV to remove the pre-gamma correction from it. Such a pre-gamma correction is usually present and was originally intended to pre-compensate the input signal IV for the gamma of a cathode ray tube. Thus, the corrected signals IV′ are present in the linear light domain. Consequently, advantageously, the signal processing performed by the signal processor or signal converter SC is performed in the linear light domain. The signal converter SC supplies its output signals which are the selected combination DC′i of drive signals FR′, FG′, FB′, FC′ to an optional gamma circuit GA which supplies the selected combination DCi of actual drive signals FR, FG, FB, FC to the data driver DD. The gamma circuit GA converts the combination of drive signals DC′i into the combination of drive values DCi to add a pre-gamma correction fitting the display panel 1 used. The de-gamma circuit DG and the gamma circuit GA may be implemented as well known lookup tables. The de-gamma circuit DG and the gamma circuit GA may be omitted. If the de-gamma circuit DG and the gamma circuit GA are not present, the gamma corrected input signal IV′ is identical to the input signal IV, and the selected combination DC′i is identical to the selected combination DCi of actual drive signals FR, FG, FB, FC.

In FIG. 1, the data driver DD receives the selected combination DCi of drive values and supplies the data signals RD1, GD1, BD1, CD1 to the four LED's PLi which emit light with the four primary colors. More than four different sets of LED's PLi may be present which each are driven by a corresponding data signal. The grey level of a LED PLi is determined by the level of the current Ii flowing through the LED PLi. For the LED's PL1, this current I1 is determined by the level of the data signal RD1 on the data electrode DE associated with the pixel drive circuit PD1. The grey level of the LED PL2 is determined by the level of the current I2 flowing through the LED PL2. The current I2 is determined by the level of the data signal GD1 on the data electrode DE associated with the pixel drive circuit PD2. And so on for the other LED's PL3 and PL4.

The timing controller TC receives the synchronization signal SY associated with the input image signal IV and supplies the control signal CR to the select driver SD and the control signal CC to the data driver DD. The control signals CR and CC synchronize the operation of the select driver SD and the data driver DD such that the selected combination DCi of the drive signals is presented at the data electrodes DE after the associated row of pixels 11 has been selected. Usually, the timing controller TC controls the select driver SD to supply select voltages to the select electrodes (also commonly referred to as address lines) SE to select (or address) the rows of pixels 11 one by one. In practice, more address lines per display row (which is a row of pixels 11) may be used, for example to control the duty cycle of the currents Ii supplied to the LED's PLi. It is possible to select more than one row of pixels 11 at a same time. The timing controller TC controls the data driver DD to supply the data signals RD1, GD1, BD1, CD1 in parallel to the selected row of pixels 10. It is also possible to arrange the different LED's in different rows and to select the different rows of sub-pixels 10.

The display panel 1 is defined to comprise the pixels 11. In a practical embodiment, the display panel 1 may also comprise all or some of the driver circuits DD, SD and TC, and even the signal converter SC. This combination of driver circuits and display panel is often referred to as display module. This display module can be used in many display apparatuses, for example in television, computer display apparatuses, game consoles, or in mobile apparatuses such as PDA's (personal digital assistant) or mobile phones.

The signal converter SC comprises a circuit RD which receives the input signal IV or IV′ to determine valid combinations PDCi of drive values DSi. These valid combinations are also referred to as the possible combinations because all these combinations PDCi of drive values DSi would give rise to the desired color (intensity and spectrum) of the combined light generated by the LED's PLi of a pixel 11. The desired color is defined by the sample of the input signal IV which should be displayed. Many possible combinations PDCi may exist to obtain the color of the pixel 11 which is intended by the input signal IV. The number of drive values DSi required in the possible combination PDCi is identical to the number of different LED's PLi of a pixel 11.

The circuit LD receives the valid combinations PDCi to determine degradation or lifetime indications PLTi which indicate the actual degradation or the expected lifetime of the LED's PLi for the drive values DSi of the valid combinations PDCi.

The circuit CD receives the indications PLTi and the valid combinations PDCi to select the selected combination DCi out of the valid combinations PDCi which provides an overall minimum degradation or maximum lifetime of the LED's of the pixel 11. Thus, for the possible combinations PDCi is first checked what the degradations or lifetimes PLTi of the LED's PLi of the pixel 11 are. Then, the combination for which the maximum degradation of the LED's of the pixel is minimal, or the minimum lifetime is maximal is selected. The circuit CD supplies the selected combination DCi of drive values to the data driver DD. The drive values of the selected combination DCi are referred to in FIG. 1 as FR, FG, FB, and FC.

Although in FIG. 1 is shown that the signal converter SC comprises the circuits RD, LD, and CD, the functions of these circuits may be performed by a single dedicated circuit or by a suitably programmed computer or ALU. Therefore, instead of circuits may be read: functional blocks.

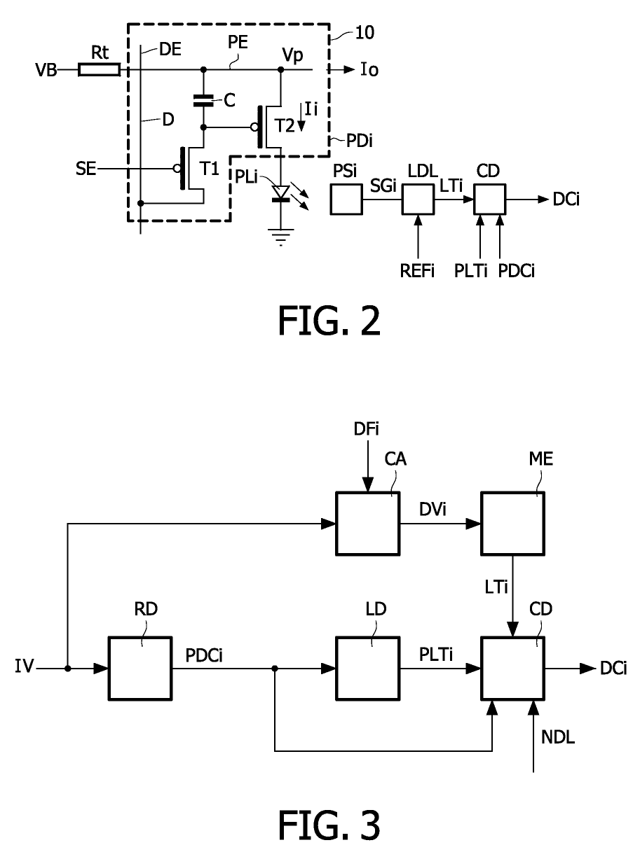

FIG. 2 shows an embodiment in accordance with the invention of a pixel drive circuit which comprises a photo-sensor. The pixel drive circuits PDi, the light emitting elements PLi, and the currents Ii shown in FIG. 1 are now collectively referred to by the index i. The pixel drive circuit PDi comprises a series arrangement of a main current path of a transistor T2 and the LED PLi. The transistor T2 is shown to be a FET but may be any other transistor type, the LED PLi is depicted as a diode but may be another current driven light emitting element. The series arrangement is arranged between the power supply electrode PE and ground (either an absolute ground or a local ground, such as a common voltage). The control electrode of the transistor T2 is connected to a junction of a capacitor C and a terminal of the main current path of the transistor T1. The other terminal of the main current path of the transistor T1 is connected to the data electrode DE, and the control electrode of the transistor T1 is connected to the select electrode SE. The transistor T1 is shown to be a FET but may be another transistor type. The still free end of the capacitor C is connected to the power supply electrode PE.

The operation of the circuit is elucidated in the now following. When a row of pixels 11 (or sub-pixels 10) is selected by an appropriate voltage on the select electrode SE with which this row of pixels 11 (or sub-pixels 10) is associated, the transistor T1 is conductive. The data signal D which has a level indicating the required light output of the LED PL is fed to the control electrode of the transistor T2. The transistor T2 gets an impedance in accordance with the data level, and the desired current Ii starts to flow through the LED PLi. After the select period of the row of pixels 10, the voltage on the select electrode SE is changed such that the transistor T1 gets a high resistance. The data voltage D which is stored on the capacitor C is kept and drives the transistor T2 to still obtain the desired current Ii through the LED PLi. The current Ii will change when the select electrode SE is selected again and the data voltage D is changed.

The current Ii has to be supplied by the power supply electrode PE which receives the power supply voltage VB via a resistor Rt. The resistor Rt represents the resistance of the power supply electrode towards the pixel 10 shown.

The pixel driving circuit PD may have another construction than shown in FIG. 2. For example, some alternative pixel driving circuits PD are disclosed in the publication “A Comparison of Pixel Circuits for Active Matrix Polymer/Organic LED Displays”, D. Fish et al, SID 02 Digest, pages 968-971.

The photo-sensor PSi is arranged such that it receives a portion of the light of the associated LED PLi. The photo-sensor PSi may receive light of more than one of the LED's PLi of the pixel 11 if these LED's are activated sequentially. The photo-sensor PSi supplies a sense signal SGi which indicates the intensity of the light generated by the LED PLi. The circuit LDL receives the sense signal SGi and a reference signal REFi to supply a degradation or lifetime indication LTi. This indication LTi is the ratio of the sense signal SGi sensed when a predetermined drive value DSi is supplied to the sub-pixel 10 and the reference signal REFi. Preferably, the reference signal REFi is the sense signal SGi sensed at the same predetermined drive value DSi at the start of a first use of the display system when the lifetime of the LED PLi is maximal. The circuit CD now also receives the indication LTi which is used to correct the selection of the selected combination DCi which was selected out of the possible combinations PDCi based on the determined lifetimes PLTi at these possible combinations. It is possible to either change the selection such that the selected combination DCi is still selected from the possible combinations PDCi but now deviating from the selection which was made based on only the determined lifetimes PLTi. Alternatively, it is possible to only change a sub-set of the drive values of the selected combination DCi. The change of the drive values of the sub-set is determined from the lifetime LTi of the pixels determined by the photo-sensor PSi, while the selected combination is still based on the determined lifetimes PLTi. However, now the luminance or color of the light generated by the pixel 11 deviates from that intended by the sample of the input signal IV (which actually generally would occur in case of degradation, without optical feedback). But, as long as this deviation is not annoyingly visible this is not a problem to the viewer.

Basically, only the correct color will be displayed if the determined lifetimes PLTi are used in case of: a) neither of the subpixels has degraded, or b) a mapping is selected such that any degraded subpixels are not used. Of course, when using the determined lifetimes LTi, it may be possible to correct the mapping to ensure the reproduction of the intended color.

FIG. 3 shows a block diagram of a signal converter of an embodiment of the invention. The signal converter SC comprises the functional blocks RD, LD, CD, CA and ME. The functional block RD receives the input signal IV and supplies the valid combinations PDCi. The block LD receives the valid combinations PDCi to determine the degradation or lifetime indications PLTi for the valid combinations PDCi. The block CD receives the valid combinations PDCi and the lifetime indications PLTi to select the selected combination DCi which provides the maximum overall lifetime. So far the combination of the blocks RD, LD and CD are identical and operate in the same manner as already discussed with respect to FIG. 1. The difference with FIG. 1 is that the block CD further receives the degradation or lifetime indications LTi and a drive level NDL of neighboring pixels 11 of the pixel 11 for which the processor SC is actually determining the selected combination DCi.

The block CA calculates, for each one of the LED's PLi a degradation value DVi indicative of the degradation or lifetime LTi of the corresponding one of the LED's PLi. This calculation is performed by using a predetermined degradation function DFi of the corresponding LED PLi and a history of drive values IV for the corresponding LED PLi. The degradation function DFi determines the degradation or the lifetime as function of the drive history of the LED PLi. The outcome may be the actual degradation so far or the still possible degradation until half the initial luminance is reached. Or the outcome may be the actual portion of the lifetime already used or the still available lifetime. The degradation function DFi may use all previous drive values to obtain the value indicating the degradation or lifetime but this requires an impractical amount of storage and computational effort for all these previous drive values. Therefore, preferably, the degradation function DFi sums for a particular pixel 11 for each sample of the input signal IV for this particular pixel 11 a delta degradation or lifetime to the previous value of the degradation function DFi. The degradation functions DFi may be different for different colored LED's PLi.

The memory ME stores the degradation values DVi determined with the degradation functions DFi to obtain stored degradation values which represent the degradation or lifetime indications LTi for each one of the LED's PLi.

The block CD selects the selected combination DCi of drive values out of the possible combinations PDCi using the received degradation or lifetime indications PLTi and LTi. The selected combination DCi of drive values is selected which provides a compromise between the minimal overall degradation, or the maximal overall lifetime of the pixel 11 based on determined degradation or lifetime indications PLTi and corrected for the degradation or lifetime indications LTi.

It is not required to determine the degradation or lifetime indication PLTi for all the LED's PLi of the sub-pixels 10 of a pixel 11. It might be sufficient to only check for two, or another subset of the different colored LED's, the indication PLTi to select the drive values for this subset such that the overall lifetime of the LED's of the subgroup is maximal.

The block CD may optionally receive a drive level NDL of neighboring pixels 11 to select the combination DCi of drive values for the actual pixel 11 to also depend on the drive level NDL of the neighboring pixels 11 such that this combination DCi of drive values is selected to deviate from the exact minimum degradation or the maximum lifetime to decrease a difference of aging of the LED's PLi of adjacent pixels 11 to minimize the so-called burn-in.

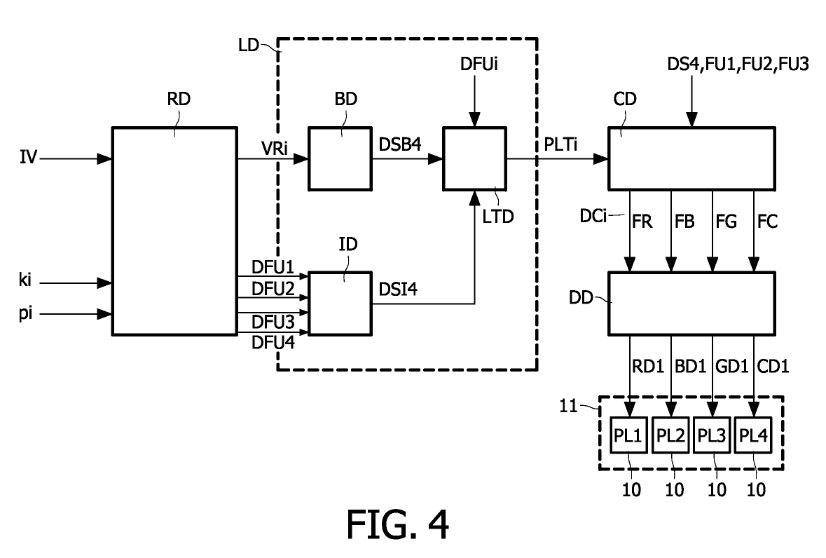

FIG. 4 shows a block diagram of a signal converter of another embodiment of the invention. In this embodiment, the pixels 11 comprise four sub-pixels all indicated by the reference 10 and which comprise the LED's PL1 to PL4, respectively. For example, red, green, blue and cyan LED's PL1 to PL4 are used. Other combinations of colors are possible, for example, instead of the cyan LED, a white or yellow LED may be used. The colors may be arranged in different orders, and need not be arranged in a line.

The functional block RD now receives the input signal IV. The functional block LD now comprises the functional blocks FUG, ID, BD and LTD.

The functional block RD defines the drive values DS1 to DS3 of the three LED's PL1 to PL3 as a function of the drive value DS4 of the fourth LED PL4. These functions are referred to as the drive functions FU1 to FU3. For example, the drive values DS1 to DS3 of the red (R), green (G), and cyan (C) LED's PL1 to PL3 are a function FU1 to FU3 of the drive value of the blue (B) LED PL4. In this example, the drive functions FU1 to FU3 are defined as:

R=FU1=a1+b1*B

G=FU2=a2+b2*B

C=FU3=a3+b3*B

The values of the references R, G, C, B are also referred to as the drive values DS1 to DS4, respectively. The coefficient matrix a, which comprises the coefficients a1 to a3, is determined by the color of the present sample of the input signal IV. The coefficient matrix b, which comprises the coefficients b1 to b3 is determined by the color points of the LED's PL1 to PL4. These matrices may for example be determined as is disclosed in ID692833.

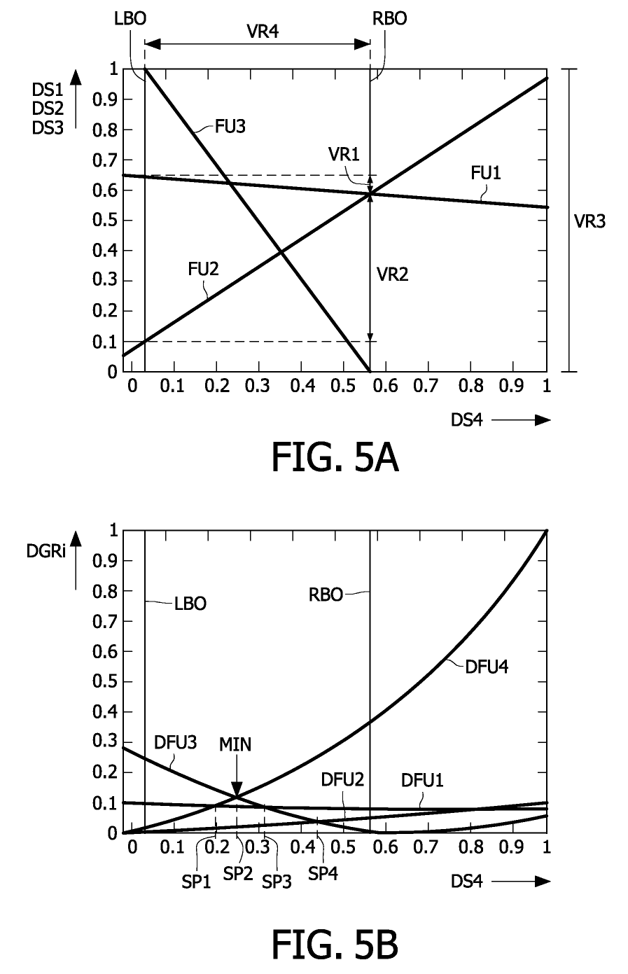

The functional block RD determines the valid range VR4 of the drive values DS4 of the LED PL4 taking into account the valid ranges VR1 to VR3 (see FIG. 5) of the LED's PL1 to PL3. The valid range VR4 indicates the possible range within the drive values DS1 to DS4 can be selected to obtain the desired color and intensity of the combined light emitted by the four LED's PL1 to PL4 fitting the present sample of the input signal IV which should be displayed. The determination of the valid range VR4 is explained in more detail with respect to FIG. 5A. As will become clear, the functions FU1 to FU3 and the drive value DS4 represent the possible combinations PDCi. For each value of the drive value DS4, the drive values DS1 to DS3 can be calculated with the functions FU1 to FU3 to obtain a set of drive values DS1 to DS4 for which the desired color is obtained.

The block RD further generates four degradation functions DFU1 to DFU4 which represent the degradation or lifetime of the four LED's PL1 to PL4, respectively. The degradation functions DFU1 to DFU3 of the LED's PL1 to PL3 are a multiplication of a constant k1 to k3, respectively, with the drive function FU1 to FU3, respectively, to the power of a power factor p1 to p3, respectively. The degradation function DFU4 of the LED PL4 is a multiplication of a constant k4 and the fourth drive value DS4 of the LED PL4 to the power of a power factor p4. The power factors p1 to p4 (indicated by pi in FIG. 4) indicate the degradation of the LED's PL1 to PL4 dependent on the associated drive values DS1 to DS4, respectively. These power factors pi typically have a value in the range 1.5 to 2.0. The constants k1 to k4 (indicated by ki in FIG. 4) indicate a degradation speed of the LED's PL1 to PL4, respectively. The degradation functions DFUi indicate the degradation DGRi of the corresponding LED's PLi and are:

DFU1=k1(a1+b1B)^{p1}

DFU2=k2(a2+b2B)^{p2}

DFU3=k3(a3+b3B)^{p3}

DFU4=k4B^{p4}.

An example of degradation functions DFU1 to DFU4 is shown in FIG. 5B.

The block ID receives the four degradation functions DFU1 to DFU4 to determine all the values DSI4 of the drive value DS4 at which the four degradation functions DFU1 to DFU4 intersect. However, in a practical implementation it is not optimal to transmit the actual degradation functions. Thus, alternatively, and more practical, the parameters ai, bi, ki, pi are transferred to the block ID. Moreover, if only the parameters ai and bi are transferred from block RD to block ID, then the parameters ki and pi can be entered directly into block ID. The block BD receives the valid range VRi and determines the border values DSB4 of the drive values DS4 taking into account the valid drive ranges VR1 to VR4 of the drive signals DS1 to DS4 of the four LED's PL1 to PL4.

The block LTD receives the values DSI4 and DSB4 and determines the degradation or lifetime indications LTi of the four LED's PL1 to PL4 for these drive values DS4 of the intersections DSI4 and the border values DSB4. Thus now, the block LD which determines the degradation or lifetime indications PLTi for possible combinations PDCi comprises the blocks ID, BD and LTD. It has to be noted that now only a few degradation or lifetime indications PLTi have to be calculated: only for the border values DSB4 and the intersect values DSI4 of the drive value DS4.

The block CD receives the fourth drive values DSI4 and DSB4, the degradation or lifetime indications PLTi at these fourth drive values DSI4 and DSB4, and the drive functions FU1 to FU3. Now, the fourth drive values DSI4 and DSB4, and the drive functions FU1 to FU3 form the possible combinations PDCi. The block CD selects from the determined degradation or lifetime indications LTi the one associated with the maximum lifetime or the minimum degradation of the combination of the LED's L1 to L4. The fourth drive value DS4 is now directly known, and the other drive values DS1 to DS3 are defined by the three drive functions FU1 to FU3, respectively. To prevent confusion by using the same references for signals at different positions in the Figure, the selected drive values DS1 to DS4 are indicated by FR, FB, FG, FC, respectively. These drive values FR, FB, FG, FC are supplied to the data driver DD which supplies the corresponding data signals RD1, BD1, GD1, CD1 to the sub-pixels 10 of the pixel 11.

The fourth drive values DSB4 of the borders can be determined as explained in more detail with respect to FIG. 5A. The determination of the fourth drive values DSI4 of the intersections is explained in more detail with respect to FIG. 5B. The selection of the optimal value of the fourth drive value DS4 is also explained in more detail with respect to FIG. 5B.

Although in this embodiment degradation functions DFUi are determined for all LED's this is not required. The same approach is valid for any number of at least two LED's. For example, if is known that the lifetime of two of the LED's PLi determine the total lifetime of the pixel 11, because the other LED's PLi have a much longer lifetime, only the degradation functions DFUi of these two fast aging LED's PLi need to be determined. Further, only the intersections of these two degradation functions DFUi have to be determined.

The functional blocks may be realized as dedicated circuits or by a suitable programmed microcomputer.

FIGS. 5A and 5B show graphs elucidating the operation of the signal converter of FIG. 4. FIG. 5A shows the drive functions FU1 to FU3, FIG. 5B shows the degradation functions DFU1 to DFU4.

FIG. 5A shows at the horizontal axis the drive value DS4 of the fourth LED PL4 which, in this example emits blue light. The drive value DS4 is normalized such that the minimum value is zero and the maximum value is one. At the vertical axis the drive values DS1 to DS3 are shown of the first to third LED PL1 to PL3 which in this example emit red, green, and cyan light, respectively. Again, the drive values DS1 to DS3 are normalized such that the minimum value is zero and the maximum value is one. The drive functions FU1 to FU3 which are defined by the earlier presented equations which represent straight lines are shown. The valid ranges VRi can be easily found in FIG. 5A. The values of all the functions FU1 to FU3 must stay within the range of drive values DS1 to DS3 ranging from zero to one. In this example, both the lower border LBO and the higher border RBO of the valid range VR4 is determined by the function FU3, because the function FU3 reaches the value 1 at the lower border LBO and the value zero at the higher border RBO while the other Functions FU1 and FU2 do not reach the limit values zero or one in-between the borders LBO and RBO. From FIG. 5A all possible combinations PDCi are the combinations of the drive value DS4 and the values of the functions FU1 to FU3 for this drive value DS4, wherein the drive value DS4 has to be selected in the range starting at the lower border LBO and ending at the higher border RBO.

FIG. 5B shows at the horizontal axis the normalized drive value DS4 and at the vertical axis the normalized degradation DGRi of the LED's PLi. An example of the degradation functions DFU1 to DFU4 is shown. The border values LBO and RBO of the drive value DS4 can be determined as is discussed with respect to FIG. 5A. The intersections of the different degradation functions DFU1 to DFU4 can be found mathematically by equating the different degradation functions DFUi of which the intersection has to be determined. If the power factors pi of these degradation functions DFUi which are equated are equal, the equation can be easily solved. If the power factors pi differ, an equation of Taylor approximations of the degradation functions DFUi may be used to determine the intersecting point. The values of the drive value DS4 at the intersections found are indicated by SP1 to SP4. The degradation DGRi of every one of the LED's PLi at the intersection drive values SP1 to SP4 and the border drive values LBO and RBO can be easily calculated from the degradation functions DFUi. The computational effort is limited because for four different LED's PLi only at maximally 6 drive values DS4, the degradation functions DFUi have to be calculated.

The block CD selects from the drive values LBO, RBO, SP1 to SP4 the drive value at which the overall degradation of the LED's PLi of the pixel 11 is minimal. In this example, the overall minimum degradation MIN occurs at the drive value SP2 where the degradation DGRi of the LED's PL3 and PL4 is equally high while the degradation DGRi of the LED's PL1 and PL2 is lower. At all other intersection drive values SP1, SP3, SP4 and at the border drive values LBO, RBO always at least one of the LED's has a degradation which is higher than the minimum degradation MIN. Thus in fact, of the intersection drive values SPi and the border drive values LBO, RBO, the one is selected of which the maximum degradation DGRi is minimal.

As is clear from the example shown in FIG. 5B, the degradation of the LED PL1, indicated by the degradation function DFU1, never will be the limiting factor in determining the optimal overall degradation. In such a situation it is more efficient to simply not take this LED into account in determining the optimal drive value DS4. Once the optimal drive value DS4 has been determined the optimal drive values DS1 to DS3 can be easily calculated with the functions FU1 to FU3.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A signal processor (SC) for converting a sample of an input signal (IV) into a selected combination (DCi) of drive values for at least four LED's (PLi) of a pixel (11) of a full color LED display to obtain a desired color of the combined light emitted by the four LED's (PLi) substantially fitting the sample of the input signal (IV), the signal processor (SC) comprises:
means (RD) for receiving the sample of the input signal (IV) to determine possible combinations (PDCi) of drive values for which the combined light emitted by the at least four LED's (PLi) substantially fits the sample of the input signal (IV),
means (LD) for receiving the possible combinations (PDCi) to determine degradation or lifetime indications (PLTi) for these possible combinations, and
means (CD) for receiving the possible combinations (PDCi) and the degradation or lifetime indications (PLTi) to determine the selected combination (DCi) as the one of the possible combinations (PDCi) providing substantially the minimum overall degradation or the maximum overall lifetime for the at least four LED's (PLi) of the pixel (11).

2. A signal processor (SC) as claimed in claim 1, wherein the means (RD) for determining the possible combinations (PDCi) are arranged for determining all possible combinations (PDCi) of drive values for which the combined light emitted by the at least four LED's (PLi) substantially fits the sample of the input signal (IV), and wherein the means (LD) for determining the degradation or lifetime indications (PLTi) are arranged for calculating the degradation or lifetime indications (PLTi) for each one of the possible combinations (PDCi), and wherein the means (CD) for determining the selected combination (DCi) is arranged for selecting from the possible combinations (PDCi) the one which provides the minimal overall degradation, or the maximal overall lifetime of the pixel (11).

3. A signal processor (SC) as claimed in claim 1, further comprising:
a calculation unit (CA) for calculating a degradation value (DVi) indicative of the degradation or lifetime (LTi) of the corresponding one of the LED's (PLi) by using a predetermined degradation function (DFi) of the corresponding LED (PLi) and a history of the samples of the input signal (IV) for the corresponding LED (PLi), and
a memory (ME) for storing the degradation values (DVi) to obtain stored degradation values (LTi),
and wherein the means (CD) for determining the selected combination (DCi) is arranged for further receiving the stored degradation values (LTi) to adapt either the selection of the selected combination (DCi) or to adapt at least one of the drive values of the selected combination (DCi) in response to the stored degradation values (LTi) to also minimize the overall degradation or the maximize the overall lifetime based on a history of drive values.

4. A signal processor (SC) as claimed in claim 1, wherein the pixels (11) comprise a photo-sensor (PSi) for supplying a sense signal (SGi) representative for a luminance of the at least one of the LED's (PLi), and wherein the signal processor (SC) further comprises means (LDL) for receiving the sense signal (SGi) and a reference signal (REFi) to determine a sensed degradation or lifetime indication (LTi) of the LED (PLi) as a ratio of the sense signal (SGi) and the reference signal (REFi), and wherein the means (CD) for determining the selected combination (DCi) is arranged for further receiving the sensed degradation or lifetime indications (LTi) to adapt either the selection of the selected combination (DCi) or to adapt at least one of the drive values of the selected combination (DCi) in response to the sensed degradation values (LTi) to also minimize the overall degradation or the maximize the overall lifetime based on a history of drive values.

5. A signal processor (SC) as claimed in claim 1, wherein the pixels (11) comprise four LED's (PLi), and wherein
the means (RD) for determining the possible combinations (PDCi) is arranged for:
defining the drive values (DS1, DS2, DS3) of a set of three (PL1, PL2, PL3) of the four LED's (PLi) as three functions (FU1, FU2, FU3), respectively, of the drive value (DS4) of a fourth one (PL4) of the four LED's (PLi),
determining a valid range (VR4) of the drive value DS4 of the fourth LED (PL4) required for obtaining a desired color and intensity of the combined light emitted by the four LED's (PLi) fitting a present sample of the input signal (IV) and taking into account the valid drive ranges (VRi) of the set of three LED's (PL1, PL2, PL3), and
expressing a degradation of the set of three LED's (PL1, PL2, PL3) by three degradation functions (DFU1, DFU2, DFU3) being a multiplication of on the one hand a constant (k1, k2, k3) indicating a degradation speed of the associated LED (PL1, PL2, PL3) and on the other hand the function (FU1, FU2, FU3) to the power of a power factor (p1, p2, p3) determining the degradation characteristic of the associated LED (PL1, PL2, PL3), and
expressing a degradation of the fourth LED (PL4) by a degradation function (DFU4) being a multiplication of on the one hand a constant (k4) indicating a degradation speed of the fourth LED (PL4) and on the other hand the fourth drive value (DS4) of the fourth LED (PL4) to the power of a power factor (p4) determining the degradation characteristic of the fourth LED (PL4),
and wherein the means (LD) for determining the degradation or lifetime indications (PLTi) is arranged for:
determining fourth drive values (DSI4) for intersections of the four degradation functions (DFU1, DFU2, DFU3, DFU4),
determining fourth drive values (DSB4) indicating border values of the valid range (VRi) of the fourth drive value (DS4), and
determining the degradation or lifetime indications (PLTi) for the four LED's (PLi) at the fourth drive values (DSI4, DSB4) determined, and
wherein the means (CD) for determining the selected combination (DCi) is arranged for selecting the one of the possible combinations (PDCi) corresponding to the determined degradation or lifetime indications (PLTi) indicating the maximum lifetime or the minimum degradation of the pixel (11).

6. A signal converter (SC) as claimed in claim 1, wherein the means (CD) for determining the selected combination (DCi) is arranged for receiving a drive level (NDL) of at least one neighboring pixel (11), wherein the selection of the selected combination (DCi) from the possible combinations (PDCi) is also based on a drive level (NDL) of the neighboring pixels (11), wherein the combination (DCi) of drive values (DSi) is selected to deviate from the exact minimum degradation or the maximum lifetime to decrease a difference of aging of LED's (PLi) of adjacent pixels (11).

7. A full color LED display system for displaying an input signal (IV) and comprising a display having pixels (11) comprising at least four LED's (PLi), respectively emitting light with four primary colors, and the signal converter (SC) as claimed in claim 1.

8. A display apparatus comprising the full color LED display system as claimed in claim 7.

9. A method of displaying an input signal (IV) on a full color LED display having pixels (11) comprising at least four LED's (PLi), respectively emitting light with four primary colors, the method comprises converting (SC) the input signal (IV) into drive signals for the at least four LED's (PLi) of a same one of the pixels (11) comprising:
determining (RD) valid ranges (VRi) of at least two of the drive signals (DSi) for obtaining a color of the combined light emitted fitting the input signal (IV),
determining (LD) a gradation or lifetime indication (LTi) of the at least two LED's (PLi) for associated ones of the drive signals (DSi) within the valid ranges (VRi), and
determining (CD) a combination (DCi) of values of drive signals (DSi) providing substantially a minimum degradation, or a maximum lifetime, of a combination of the at least two LED's (PLi) based on the degradation or lifetime indications (LTi).
